(19) United States
(12) Patent Application Publication
(10) Pub. No.: US 2011/0155956 A1
(43) Pub. Date: Jun. 30, 2011

(54) Fibers Including Nanoparticles And A Method Of Producing The Nanoparticles

(76) Inventors: Muhammad Ather Ashraf, Midland, MI (US); Byung Keun Hwang, Midland, MI (US); Bonnie J. Ludwig, Midland, MI (US)

(21) Appl. No.: 13/061,214

(22) PCT Filed: Aug. 19, 2009
(86) PCT No.: PCT/US2009/054306

§ 371 Date: Feb. 28, 2011

(30) Foreign Application Priority Data
Aug. 29, 2008 (US) 61190542
Aug. 19, 2009 (US) PCT/US2009/054306

(51) Int. Cl. C09K 11/06; B29C 47/00; B29C 71/00; G02B 1/10; B82Y 40/00; B82Y 20/00

(52) U.S. Cl. 252/301.16; 264/465; 216/53; 264/1.36; 977/888; 977/901; 977/773

(57) ABSTRACT

A method produces nanoparticles by electrospinning a silicon composition having at least one silicon atom. The electrospinning of the silicon composition forms fibers. The fibers are pyrolyzed to produce the nanoparticles. The nanoparticles have excellent photo-luminescent properties and are suitable for use in many different applications.

### FIELD OF THE INVENTION

The present invention generally relates to nanoparticles. More specifically, this invention relates to nanoparticles produced from a silicon composition that are photoluminescent and also to a method of producing the nanoparticles from the silicon composition.

### DESCRIPTION OF THE RELATED ART

Nanoparticles and methods of making nanoparticles are known to those skilled in the art of nanotechnology and have immense potential in diverse applications including optical, electronic, and biomedical applications. Nanoparticles are particles having at least one dimension of less than 100 nanometers and are produced either from a bulk material, which is initially larger than a nanoparticle, or from particles smaller than the nanoparticles, such as ions and/or atoms. Nanoparticles are particularly unique in that they have significantly different properties than the bulk material or the smaller particles from which the nanoparticles are derived. For example, a bulk material that acts as an insulator or semiconductor can, if in nanoparticle form, be electrically conductive.

One method of producing nanoparticles starting with the bulk material is attrition. In this method, the bulk material is disposed in a mill, e.g. a ball mill, a planetary ball mill, a grinder, etc., thereby reducing the bulk material to nanoparticles and other larger particles. The nanoparticles can be separated from the other larger particles via air classification. However, existing mills currently used in milling applications are typically not specially adapted to form the nanoparticles. For example, the mills can introduce contaminants from outside sources as well as contaminants from erosion of the mill. The contaminants can have adverse effects on the properties of the nanoparticles and make separation of the nanoparticles from the other larger particles difficult.

Nanoparticles have also been produced by laser ablation utilizing a pulsed laser. In laser ablation, bulk metals are placed in aqueous and/or organic solvents and the bulk metals are exposed to the pulsed laser (e.g. copper vapor or neodymium-doped yttrium aluminum garnet). The nanoparticles are ablated from the bulk metal by laser irradiation and subsequently form a suspension in the aqueous and/or organic solvents. However, the pulsed laser is expensive and, additionally, the nanoparticles produced from laser ablation are typically limited to metal nanoparticles.

Nanoparticles having photoluminescent properties, e.g. silicon nanoparticles, silicon carbide nanoparticles, and carbon nanoparticles, have been the object of much research due in part to these nanoparticles having potential for use in a wide variety of applications, such as fluorescent biological imaging, semiconductors, microchips, and optical devices. Currently, dyes are used in fluorescent biological imaging. The dyes degrade under photoexcitation, exposure to light, and/or elevated temperatures. However, the nanoparticles do not degrade under similar conditions and, therefore, have excellent properties in comparison to existing dyes used in fluorescent biological imaging. Moreover, as set forth above, the nanoparticles having the photoluminescent properties have potential for use in applications beyond fluorescent biological imaging.

The current method of producing nanoparticles having photoluminescent properties is electrochemical treatment. In typical electrochemical treatment, a solution of hydrofluoric acid, hydrogen peroxide, and methanol is formed. A platinum cathode is placed into the solution and a silicon anode is slowly placed into the solution while applying a current between the platinum cathode and the silicon anode. Silicon nanoparticles form on a surface of the silicon anode. The silicon nanoparticles are then separated from the silicon anode by immersing the silicon anode in a solvent bath or by ultrasound treatment. This method is labor intensive, expensive, requires extensive laboratory equipment, and produces very few silicon nanoparticles in batch. As such, there is a general desire to provide for a method which produces nanoparticles, including silicon nanoparticles, having excellent properties and suitable for use in diverse applications.

In view of the foregoing, it would be advantageous to provide nanoparticles having, among other improved physical properties, excellent photoluminescent properties. It would be further advantageous to provide for a method of producing the nanoparticles such that a large number of nanoparticles can be produced from diverse materials and blends of materials.

### SUMMARY OF THE INVENTION AND ADVANTAGES

A method of producing nanoparticles is disclosed. The present invention also includes fibers comprising the nanoparticles. The fibers are formed by electrospinning a silicon composition with an electrospinning apparatus. The fibers are pyrolyzed to produce the nanoparticles. The nanoparticles are produced within and/or on the fibers.

The present invention provides a method of producing large quantities of nanoparticles with minimal steps. Parameters of the step of pyrolyzing can be adjusted to produce nanoparticles having a desired size for a specific application. In addition, the step of pyrolyzing does not require expensive or specialty laboratory equipment when compared to existing methods utilizing lasers. Also, the nanoparticles of the present invention have excellent photoluminescent properties, which make the nanoparticles ideal for numerous applications, including optical, electronic, and biological applications.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an optical microscope image of a plurality of fibers after electrospinning at 50× magnification;

FIG. 2 is an optical microscope image of the fibers comprising nanoparticles after the step of pyrolyzing the fibers at 20× magnification;

FIG. 3 is an optical microscope image of the fibers including a nanoparticle after the step of etching the fibers at 50× magnification;

FIG. 4 is a graph of a photoluminescent spectra of the fibers wherein normalized intensity is a function of wavelength;

FIG. 5 is an SEM image of the fibers at 50× magnification;

FIG. 6 is an SEM image of the fibers at 250× magnification; and

FIG. 7 is an SEM image of the fibers at 2000× magnification.

### DETAILED DESCRIPTION OF THE INVENTION

The present invention provides for fibers comprising nanoparticles, nanoparticles isolated from the fibers, and a method of producing the nanoparticles. The nanoparticles are photoluminescent and have potential use in numerous applications including, but not limited to, optical, electronic, and biological applications.

To form the fibers, a silicon composition is provided and is electrospun with an electrospinning apparatus. The term “silicon composition,” as used herein, is encompasses any composition having at least one silicon atom therein. The silicon atom can be a substituent pending from a polymer backbone or the silicon atom can be a part of the polymer backbone. Further, the silicon composition is not limited to a polymer; the silicon composition can comprise, for example, a disilane. Silicon compositions suitable for use in the present invention can include, but are not limited to, hydrogen silsesquioxane, methyl silsesquioxane, disilane, polysilane, toluhydroquinone having at least one silicon atom, and combinations thereof. The silicon composition typically has the general structure:

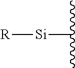

wherein R can be any moiety and is not limited to an organic moiety; and the broken silicon bond is optional and is not limited to one bond. For example, the silicon atom can be bonded only to R. In addition, the broken silicon bond can represent a plurality of bonds, such as in a silsesquioxane in which the silicon atom is typically bonded to three oxygen atoms in addition to the R bond. The broken silicon bond can also represent a single bond, double bond, and/or a triple bond.

When the silicon composition comprises at least one carbon atom, e.g. the R is an organic moiety, the nanoparticles produced therefrom can include carbon nanoparticles and silicon carbide nanoparticles in addition to the silicon nanoparticles set forth above. In addition to the silicon nanoparticles, carbon nanoparticles, and silicon carbide nanoparticles, further examples of nanoparticles produced by the method of the present invention include SiC₄ nanoparticles, SiC₃₀ nanoparticles, SiC₂O₂ nanoparticles, SiCO₃ nanoparticles, and SiO₄ nanoparticles.

The silicon composition may be in powder form. When the silicon composition is in the powder form, the silicon composition may be dissolved in a solvent prior to electrospinning the silicon composition to form the fibers. The solvent is typically an organic solvent and can be any organic solvent known in the art so long as the organic solvent is capable of dissolving the silicon composition in the powder form. In one embodiment, the organic solvent is a ketone, such as methyl isobutyl ketone. It is to be appreciated that the silicon composition can be dissolved in two or more solvents, i.e., a blend of solvents. In the embodiment in which the silicon composition is dissolved in the organic solvent, the silicon composition can be present in any amount greater than zero and less than 100. The silicon composition is typically present in an amount of from 5 to 95, more typically 65 to 85, most typically 70 to 80, parts by weight, based on 100 parts by weight of the silicon composition and the solvent.

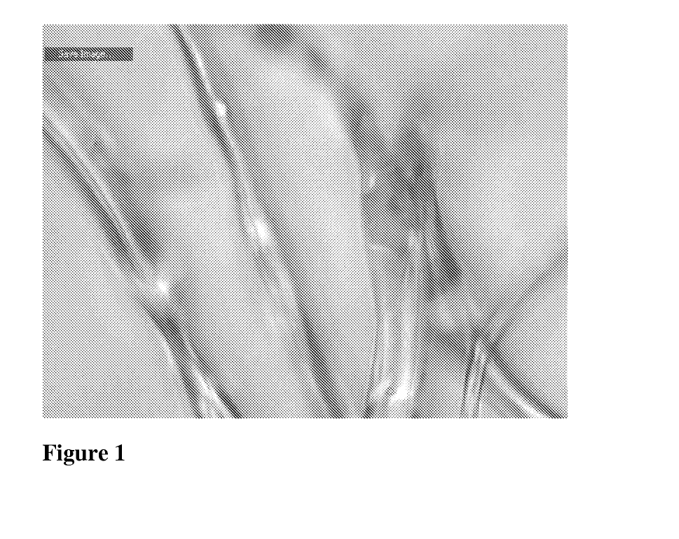

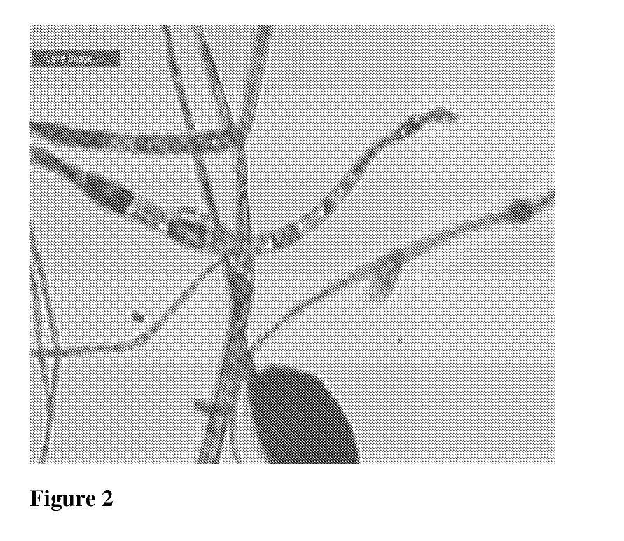

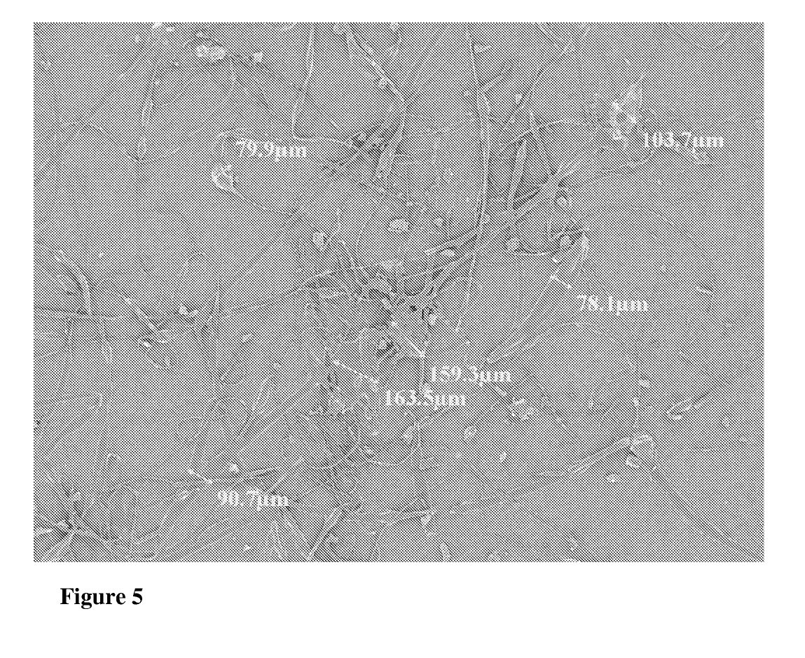

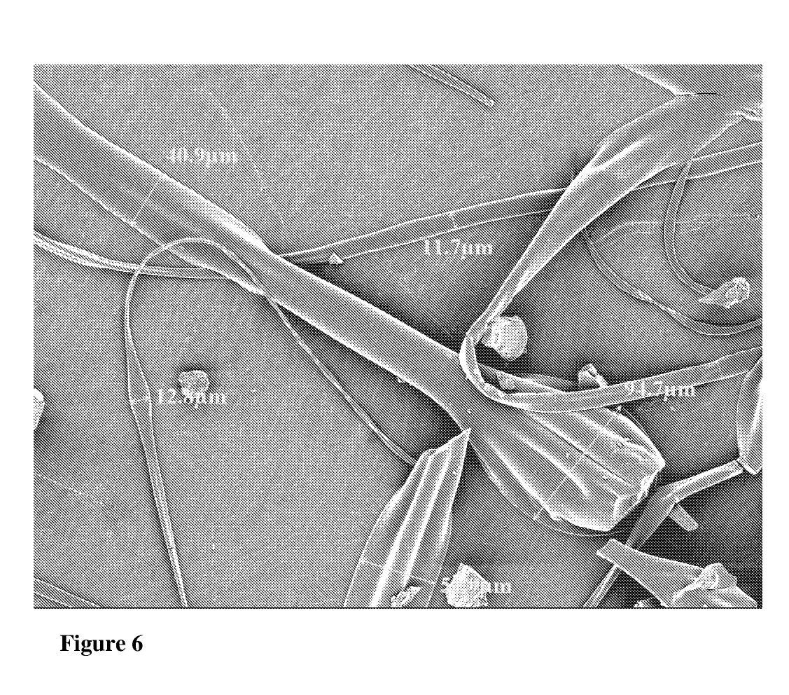

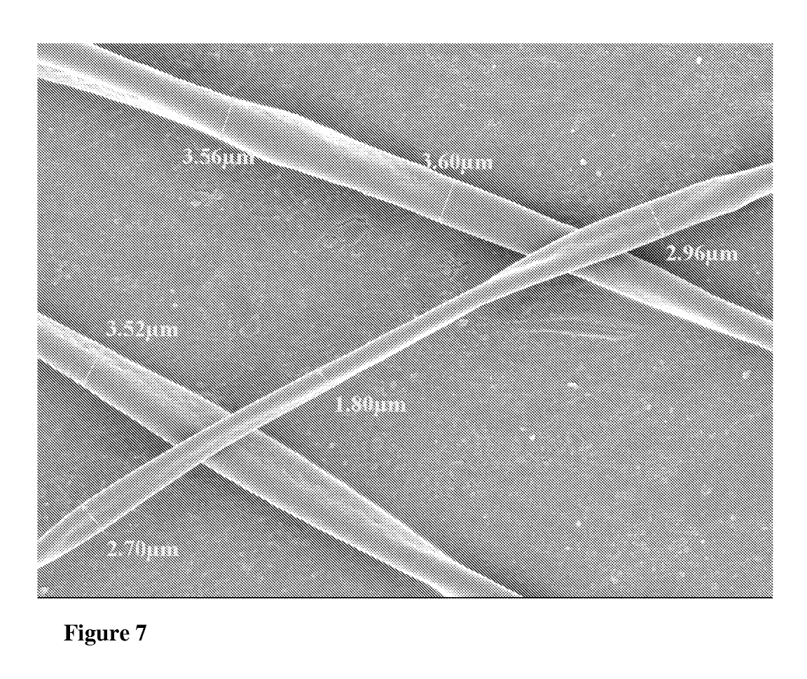

The silicon composition is electrospun with the electrospinning apparatus to form the fibers. The fibers can be woven or non-woven. In one embodiment, as shown in FIGS. 1-3 and 5-7, the fibers are non-woven. As illustrated in these Figures, the fibers typically range in diameter of from 1 to 200 μm, more typically from 5 to 100, most typically from 12 to 67 μm. However, the fibers can have any diameter without departing from the scope of the present invention. Typically, as illustrated in FIG. 5, the diameters of the fibers vary and are non-uniform. In addition, the fibers can have any length without departing from the scope of the present invention. For example, as illustrated in FIG. 5, the fibers may be continuous.

The silicon composition can be provided by any method known in the art. For example, the silicon composition can be batch fed to the electrospinning apparatus, semi-continuously fed to the electrospinning apparatus, and continuously fed to the electrospinning apparatus.

The electrospinning apparatus can be any electrospinning apparatus known in the art. The electrospinning apparatus typically includes a nozzle and a collector spaced from the nozzle. The electrospinning apparatus can have one or more nozzles and/or collectors. The nozzle can be any nozzle known in the art. For example, the nozzle can be a spinneret, a pipette, or a syringe including a needle. The nozzle can be formed from a metal such as stainless steel. However, the nozzle can be formed from other materials known in the art. The nozzle defines a hole. The hole can be any shape and typically has a diameter of from 10 to 50, more typically from 20 to 40, most typically 30, gauge (G) in size. It is to be appreciated that more than one nozzle can be used to form the fiber. For example, a first nozzle can have a 30 gauge hole, and a second nozzle can have a 50 gauge hole. The first and second nozzles can be used simultaneously or one after another to form two fibers of differing diameters.

The collector can be any collector known in the art. The collector can be formed from a metal such as stainless steel. However, the collector can be formed from other materials known in the art. In one embodiment, the collector is an aluminum oxide (Al₂O₃) wafer. In another embodiment, the collector is a silicon and/or silica wafer. The collector can also comprise combinations of different materials, such as aluminum oxide coated with silicon. The collector can be stationary or can be moving, e.g. rotating, relative to the nozzle while electrospinning the silicon composition to form the fibers. In addition or alternatively, the nozzle can be stationary or can be moving, e.g. translating, relative to the collector while electrospinning the silicon composition to form the fibers. It is to be appreciated that the nozzle and or the collector can change from stationary to moving or vice versa during one or more instances while forming the fibers. Moving at least one of the nozzle and the collector can be useful for controlling a direction the fibers will lay while forming.

The nozzle can be any distance from the collector. Typically, the nozzle is spaced a distance of from 1 to 100, more typically from 10 to 40, most typically from 20 to 30, centimeters (cm) from the collector. In one embodiment, the nozzle and the collector are maintained at a constant distance from each other while electrospinning the silicon composition to form the fibers. In other embodiments, the distance between the nozzle and the collector can be increased and/or decreased while electrospinning the silicon composition to form the fibers. It is to be appreciated that the distance can change during one or more instances while forming the fibers.

An electrical potential is typically created between the nozzle and the collector. However, it is to be appreciated that the collector can not be part of the electrical potential. For example, the collector can be placed between the nozzle and a second collector, wherein the electrical potential is between the nozzle and the second collector. The electrical potential can be created by any method known in the art. For example, the electrical potential can be created by one or more power supplies attached to the nozzle and the collector. It is to be appreciated that separate power supplies can be attached to the nozzle and the collector, respectively. The power supply should be able to provide a high-voltage for creating the electrical potential. The electrical potential can be of any voltage. Typically, the electrical potential is from 1 to 100, more typically from 20 to 40, and most typically from 25 to 35, kilovolts (kV). It is to be appreciated that the electrical potential can be constant or can vary while forming the fibers.

In one embodiment, pressure is applied to the silicon composition while electrospinning the silicon composition to form the fibers. The pressure can be any pressure. The pressure can be applied to the silicon composition by any method known in the art. For example, the pressure can be applied to the silicon composition by a pump attached to the nozzle. If employed to form the fibers, the pressure can be constant or can vary while forming the fibers.

The pressure can be associated with a flow rate of the silicon composition supplied to and/or through the nozzle. For example, a feeder, such as a pump, can supply the nozzle with the silicon composition. The feeder can be any feeder known in the art. The flow rate can be any flow rate. Typically, the flow rate of the silicon composition is from greater than zero to 100, more typically from 0.01 to 10, most typically from 0.1 to 1, milliliters per minute (mL/min). It is to be appreciated that the flow rate can be constant or can vary while forming the fibers.

It is to be appreciated that the silicon composition may be electrospun with the electrospinning apparatus while the silicon composition is dissolved in the solvent. In this embodiment, the solvent typically evaporates as the silicon composition is electrospun by the electrospinning apparatus, thereby forming the fibers. Alternatively, the silicon composition may be free from any solvents and melted prior to and/or during the electrospinning of the silicon composition. For example, when the silicon composition has a relatively low melting point, e.g. a melting point of less than 300° C., the silicon composition can be electrospun without first being dissolved in the solvent. In this embodiment, the silicon composition may be melted prior to being supplied to the electrospinning apparatus or the silicon composition may be melted within the electrospinning apparatus. For example, the silicon composition may be melted by the nozzle such that the silicon composition melts as it is being electrospun to form the fibers. This process is commonly referred to in the art as melt-electrospinning.

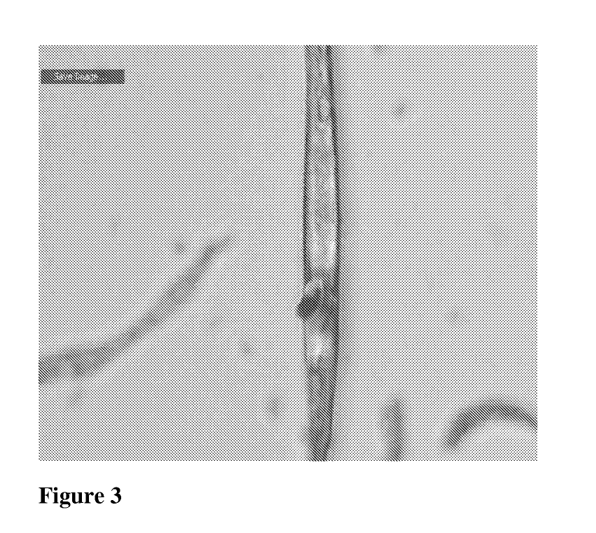

In the present invention, it has been determined that pyrolysis of the fibers at specific parameters produces the nanoparticles within and/or on the fibers. Pyrolysis refers to chemical decomposition of a bulk material to form small molecules and/or particles. The nanoparticles produced by pyrolysis of the fibers may be encapsulated by the fibers and/or the nanoparticles may be in contact with the fibers such that the nanoparticles are not encapsulated by the fibers. For example, FIG. 3 illustrates a nanoparticle formed by the method of the present invention that is partially protruding from a fiber. It is to be appreciated that a size of the nanoparticles is a function of many variables, including the diameter of the fibers. Therefore, as set forth above, the parameters of the electrospinning apparatus may be adjusted by one skilled in the art to form the fibers having a desired diameter. Typically, the diameter of the fibers and the size of the nanoparticles have a direct relationship, i.e., as the diameter of the fibers increases, the size of the nanoparticles produced therein and/or thereon increases as well.

The fibers may be pyrolyzed after electrospinning the silicon composition to form the fibers. Alternatively, the fibers may be pyrolyzed while the fibers are being formed by electrospinning. The fibers can be pyrolyzed in different manners including, but not limited to, heating and plasma treating the fibers. For descriptive purposes only, only heating and plasma treating to pyrolyze the fibers are described additionally below.

In one embodiment, the step of pyrolyzing the fibers comprises heating the fibers. The fibers can be heated in any manner known in the art including, but not limited to, rapid thermal processing, an inductive furnace, a tube furnace, a vacuum furnace, an oven, and a microwave. In one embodiment, the step of pyrolyzing the fibers is carried out in an inert or reducing environment. The inert or reducing environment is employed to minimize and/or eliminate oxidation of the fibers and/or the nanoparticles. The inert or reducing environment typically comprises nitrogen gas, hydrogen gas, helium gas, argon gas, and combinations thereof.

In the embodiment in which in the step of pyrolyzing the fibers comprises heating, the fibers are typically heated to a temperature of from 400 to 2,500, more typically from 900 to 2,200, most typically from 1,000 to 1,700, ° C. The temperature of the fibers is typically increased from ambient temperature to the temperature of from 400 to 2,500° C. at a rate greater than 5° C. per minute. In one embodiment, the rate is 25° C. per minute. Once the fibers have been heated to the temperature of from 400 to 2,500° C., the fibers are typically heated for a time of from 0.1 to 20, more typically from 0.5 to 5, most typically from 0.8 to 3, hours. It is to be appreciated that the time during which the fibers are heated after reaching the temperature of from 400 to 2,500° C. does not include the time during which the temperature of the fibers is being increased at the rate greater than 5° C. per minute. The time during which the temperature of the fibers is being increased is easily calculable based on the rate that is chosen along with the ambient and final temperatures.

It is to be appreciated that, as set forth above, the size of the nanoparticles produced by the step of pyrolyzing is typically a function of many variables, including the temperature at which the fibers are heated. Therefore, one skilled in the art can adjust the parameters during the step of pyrolyzing the fibers so as to produce the nanoparticles having a desired size. The nanoparticles produced in the present invention typically have an average diameter of from greater than zero to 500 nanometers. In the embodiment in which the step of pyrolyzing the fibers comprises heating the fibers to the temperature of from 400 to 2,500° C., heating the fibers to a temperature of from 800 to 1,400° C. produces nanoparticles having an average diameter of from greater than zero to 7 nanometers. Similarly, it is to be appreciated that when the step of pyrolyzing the fibers comprises heating the fibers to the temperature of from 400 to 2,500° C., heating the fibers to a temperature of from 400 to 800° C. can produce nanoparticles having the average diameter of from greater than zero to 7 nanometers; however, heating the fibers at a lower temperature, i.e. from 400 to 800° C., typically requires the fibers be heated for a longer period of time, for example, 5 hours rather than 2 hours while heated from 800 to 1,400° C. When the step of pyrolyzing the fibers comprises heating the fibers to the temperature of from 400 to 2,500° C., heating the fibers to a temperature of greater than 1,400 to 2,500° C. produces nanoparticles having an average diameter of from greater than 7 to 500 nanometers. For example, when the fibers are heated at a temperature of 1,500° C., nanoparticles are produced having an average diameter of from 50 to 80 nanometers. When the fibers are heated to a temperature of 1,700° C., nanoparticles are produced having an average diameter of from 130 to 170 nanometers. It is to be appreciated that the phrase “average diameter,” as used herein, is to be interpreted as the smallest dimension of each of the nanoparticles. Further, the nanoparticles may have asymmetrical or nonspherical shapes. For example, at least one of the nanoparticles can resemble a tube having a length of 10 micrometers and a width of 5 nanometers, and the tube will still be within the scope of the nanoparticles of the present invention because the diameter of the tube is 5 nanometers.

Typically, when the step of pyrolyzing the fibers comprises heating the fibers, the nanoparticles are produced along with silicon dioxide. In other words, the fibers comprise silicon dioxide having the nanoparticles dispersed therein and/or thereon. Further, although the fibers comprise silicon dioxide and include the nanoparticles, the fibers typically do not structurally decompose at any stage during or after the step of pyrolyzing the fibers. The fibers including the nanoparticles can have uses in applications, such as microchips, due to the electrical conductivity of the fibers including the nanoparticles.

As indicated above, in another embodiment, the step of pyrolyzing the fibers comprises plasma treating the fibers. Plasma treating bombards the fibers with plasma. Typically, the step of pyrolyzing the fibers comprises plasma treating the fibers at a temperature of less than 400° C., more typically from a temperature from 25 to 350, and most typically from 25 to 200, ° C. The fibers are typically plasma treated at the temperature of less than 400° C. for a time of from greater than zero to 10, more typically from 2 to 8, most typically from 4 to 6, minutes. The step of pyrolyzing comprising plasma treating the fibers can utilize any plasma known in the art. In one embodiment, the plasma is inert or reducing plasma. For example, the plasma can be hydrogen, argon, nitrogen, and combinations thereof. Bombarding the fibers with the plasma cleaves chemical bonds of the fibers, resulting in the production of the nanoparticles.

As set forth above, there are several uses for the fibers comprising the nanoparticles after the step of pyrolyzing the fibers. In other words, there are many applications for the fibers. However, the nanoparticles may also be isolated from the fibers.

The step of isolating the nanoparticles typically comprises etching the fibers with an acidic solution. The acidic solution must be sufficiently corrosive to dissolve the fibers comprising the silicon dioxide having the nanoparticles dispersed therein and/or thereon. The acidic solution is aqueous and typically comprises hydrofluoric acid, nitric acid, and combinations thereof, in deionized water. In one embodiment, the acidic solution comprises hydrofluoric acid in an amount of 49% by weight, based on the total weight of the acidic solution.

In one embodiment of the present invention, the acidic solution further comprises a wetting agent. The wetting agent is employed to increase a surface area contact between the acidic solution and the fibers. For example, the acidic solution tends to form droplets when placed on the fibers and, accordingly, the surface area contact is minimal. When the acidic solution includes the wetting agent, the surface area contact between the acidic solution and the fibers increases while the volume of the acidic solution remains constant. Therefore, the acidic solution comprising the wetting agent requires a smaller volume in comparison to the acidic solution not having the wetting agent for the same surface area contact between the acidic solution and the fibers. In one embodiment, the wetting agent is an alcohol. The alcohol can be any alcohol known in the art. One example of a suitable alcohol is ethanol. The alcohol is typically present in the acidic solution in an amount of from greater than 0 to 85, more typically from 10 to 60, and most typically from 20 to 40 parts by volume, based on 100 parts by volume of the acidic solution.

The step of etching the fibers with the acidic solution dissolves the fibers comprising the silicon dioxide having the nanoparticles dispersed therein and/or thereon and forms an etched solution having the nanoparticles dispersed therein. The step of etching the fibers comprises contacting the fibers with the acidic solution. The acidic solution can be poured or dripped onto the fibers or the fibers can be submerged or disposed in the acidic solution. In the embodiment in which the fibers are disposed in the acidic solution, the acidic solution can be contained in any container known in the art to contain highly corrosive liquids. To dissolve the fibers, the fibers are typically in contact with the acidic solution for a time of from 0.1 to 60, more typically from 1 to 20, most typically from 1 to 5, minutes. The fibers are typically in contact with the acidic solution at ambient temperature. However, it is to be appreciated that the acidic solution can be heated prior to and/or contemporaneous with contacting the fibers with the acidic solution. Further, energy, such as ultrasonic and/or megasonic energy, can be applied to the fibers, the acidic solution, or both, to increase the interaction between the fibers and the acidic solution, thereby increasing a rate at which the fibers dissolve in the acidic solution. It is to be appreciated that after the step of etching the fibers with the acidic solution, nanoparticles may remain on the substrate, i.e., not all of the nanoparticles will be dispersed in the etched solution.

The etched solution, including the nanoparticles dispersed therein, is corrosive due to the acidic solution. As such, the corrosiveness of the etched solution can inhibit use of the nanoparticles in most applications utilizing the nanoparticles. Therefore, in one embodiment, the method further comprises the step of mixing the etched solution with an organic liquid. The organic liquid serves to reduce the corrosiveness of the etched solution and the organic liquid, while mixed. Further, the organic liquid and the etched solution are immiscible and, therefore, it is to be appreciated that mixing the etched solution and the organic liquid results in two phases, e.g. the etched solution and the organic liquid. Mixing the etched solution with the organic liquid induces the nanoparticles to transfer from one phase to the other, i.e., from the etched solution to the organic liquid. The inherent physical properties of the nanoparticles induce the nanoparticles to transfer from the etched solution to the organic liquid, e.g. non-polarity. In one embodiment, the organic liquid comprises a long chain hydrocarbon, such as octane. The organic liquid may comprise a blend of organic liquids. For example, if the nanoparticles do not fully transfer from one phase to the other, e.g. the etched solution to the organic liquid, upon mixing the organic liquid with the etched solution, a polar organic solvent, such as methyl isobutyl ketone, can be utilized to further transfer the nanoparticles from the etched solution. The step of mixing the etched solution with the organic liquid can comprise separate steps of mixing the etched solution with the long chain hydrocarbon and subsequently mixing the etched solution with the polar organic solvent. Alternatively, the step of mixing the etched solution with the organic liquid may include a single step in which the organic liquid comprising the long chain hydrocarbon and the polar organic solvent are mixed simultaneously with the etched solution. In the embodiment in which the step of mixing the etched solution with the organic liquid comprises separate steps, the long chain hydrocarbon can be separated from the etched solution prior to mixing the etched solution with the polar organic solvent. Alternatively, the long chain hydrocarbon can remain mixed with the etched solution while mixing the polar organic solvent therein. The etched solution and the organic liquid can be mixed by any method known in the art of chemistry, such as shaking, stirring, magnetic stirring, static mixers, vortex mixers, blenders, etc. For example, the etched solution may be disposed in a flask, and the organic liquid may be disposed therein. The etched solution and the organic liquid may be mixed by disposing a stopper in the flask and shaking. The etched solution and the organic liquid will separate into two phases, as set forth above, and the nanoparticles are dispersed throughout the organic liquid rather than the etched solution.

In one embodiment, the method further comprises the step of separating the etched solution from the organic liquid. The organic liquid and the etched solution are typically immiscible, allowing for physical separation of the organic liquid and the etched solution. The organic liquid can be separated from the etched solution by any method known in the art, including physical and/or chemical separation. Due to the immiscibility of the etched solution and the organic liquid, in one embodiment, the organic liquid, having the nanoparticles dispersed therein, is separated from the etched solution via decantation.

It is to be appreciated that, if desired, the nanoparticles can be separated and/or removed from the organic liquid. The nanoparticles can be separated and/or removed from the organic liquid by any method, such as centrifugation.

As set forth above, the nanoparticles include silicon nanoparticles. The nanoparticles can further include carbon nanoparticles, silicon carbide nanoparticles, and combinations thereof, dependent upon the silicon composition. For example, when the silicon composition comprises hydrogen silsesquioxane, silicon nanoparticles are produced by electrospinning and pyrolyzing the hydrogen silsesquioxane. When the silicon composition comprises methyl silsesquioxane, silicon nanoparticles, carbon nanoparticles, and/or silicon carbide nanoparticles are produced by electrospinning and pyrolyzing the methyl silsesquioxane. As set forth above, the average diameter of the nanoparticles is dependent upon the pyrolyzing parameters, such as temperature and time, as well as the diameter of the fibers. However, it is to be appreciated that nanoparticles having photoluminescent properties typically have an average diameter of from greater than zero to less than 7 nanometers. Further, it is to be appreciated that the color of the photoluminescence can be a function of several factors, including the size of the nanoparticles and whether the nanoparticles are silicon nanoparticles, carbon nanoparticles, or silicon carbide nanoparticles. The color of the photoluminescence can be any color, such as orange, blue, green, etc. Although nanoparticles can be produced having an average diameter of greater than 7 nanometers, the nanoparticles having the average diameter of greater than 7 nanometers will typically not exhibit photoluminescence and, as such, will not be visible under conditions necessary to induce photoluminescence. However, the nanoparticles having the average diameter of greater than 7 nanometers can have uses other than those requiring photoluminescence, such as uses in the semiconductor industry and/or the printable ink industry.

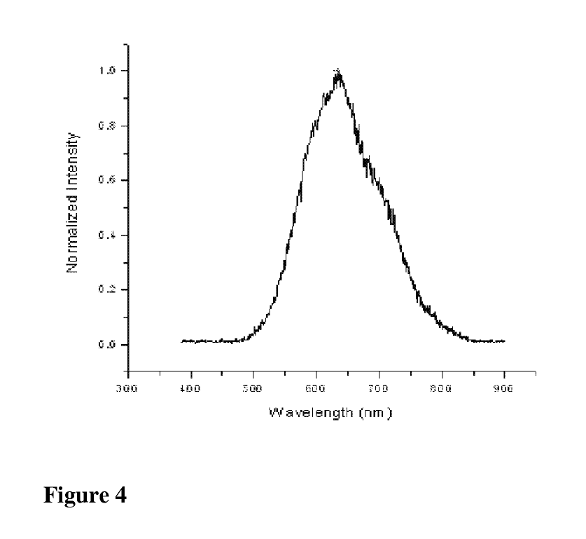

To induce the photoluminescence of the nanoparticles, any method known in the art to transmit electromagnetic radiation can be utilized. In one embodiment, the nanoparticles are subjected to ultraviolet light to induce photoluminescence of the nanoparticles. The ultraviolet light typically has a wavelength of from 250 to 400 nm. FIG. 4 illustrates a graph of a photoluminescent spectra of nanoparticles made in accordance with the method of the present invention, wherein normalized intensity is a function of wavelength with an excitation of 365 nm. Photoluminescence of the nanoparticles occurs when each of the nanoparticles absorb a photon, causing an excitation of the nanoparticles to a higher energy state, followed by a return to a lower energy state and an emission of the photon. It is to be appreciated that the nanoparticles can exhibit photoluminescence after being isolated from the organic liquid, while dispersed throughout the organic liquid, while in the etched solution, while in the fibers, and while in the fibers on the collector.

The following examples, illustrating the method of forming the fibers and producing the nanoparticles of the present invention, are intended to illustrate and not to limit the invention.

### EXAMPLES

### Example 1

A silicon composition comprises hydrogen silsesquioxane. The hydrogen silsesquioxane is dissolved in methyl isobutyl ketone in a ratio of 3:1 hydrogen silsesquioxane to methyl isobutyl ketone based on weight. The hydrogen silsesquioxane dissolved in the methyl isobutyl ketone is electrospun onto a silicon wafer, i.e., a collector, to form a plurality of fibers. The electrical potential between the nozzle and the collector is 30 kV. The gap between the nozzle and the collector is 25 cm. The flow rate of the hydrogen silsesquioxane dissolved in the methyl isobutyl ketone through the nozzle is 1 mL/min. The fibers are spun for about 1 minute. The fibers are pyrolyzed by heating the fibers from ambient temperature at a rate of 25° C./min until the fibers reach a temperature of 1,200° C. The fibers are heated at the temperature of 1,200° C. for one hour. The fibers are pyrolyzed in an environment comprising nitrogen gas and hydrogen gas, which are inert and free of oxygen, to form nanoparticles. The fibers are etched with an acidic solution comprising a 1:1:1 ratio of 49% hydrofluoric acid:alcohol:deionized water by submerging the fibers in the acidic solution to form the etched solution. The nanoparticles are removed from the etched solution by mixing the etched solution with an organic liquid comprising octane and methyl isobutyl ketone. The organic liquid, having the nanoparticles dispersed therein, is decanted from the etched solution. The nanoparticles are exposed to 365 nm ultraviolet light, during which the nanoparticles exhibit red photoluminescence, as described in Table 1 below.

### Example 2

A silicon composition comprises hydrogen silsesquioxane. The hydrogen silsesquioxane is dissolved in methyl isobutyl ketone in a ratio of 3:1 hydrogen silsesquioxane to methyl isobutyl ketone based on weight. The hydrogen silsesquioxane dissolved in the methyl isobutyl ketone is electrospun onto a silicon wafer i.e., a collector, to form a plurality of fibers. The electrical potential between the nozzle and the collector is 30 kV. The gap between the nozzle and the collector is 25 cm. The flow rate of the hydrogen silsesquioxane dissolved in the methyl isobutyl ketone through the nozzle is 1 mL/min. The fibers are spun for about 1 minute. The fibers are pyrolyzed by heating the fibers from ambient temperature at a rate of 25° C./min until the fibers reach a temperature of 1,500° C. The fibers are heated at the temperature of 1,500° C. for one hour. The fibers are pyrolyzed in an environment comprising nitrogen gas and hydrogen gas, which are inert and free of oxygen, to form nanoparticles. The fibers are etched with an acidic solution comprising a 1:1:1 ratio of 49% hydrofluoric acid:alcohol:deionized water by submerging the fibers in the acidic solution to form the etched solution. The nanoparticles are removed from the etched solution by mixing the etched solution with an organic liquid comprising octane and methyl isobutyl ketone. The organic liquid, having the nanoparticles dispersed therein, is decanted from the etched solution. The nanoparticles are exposed to 365 nm ultraviolet light, during which the nanoparticles do not exhibit photoluminescence, as described in Table 1 below.

### Example 3

A silicon composition comprises methyl silsesquioxane. The methyl silsesquioxane is dissolved in methyl isobutyl ketone in a ratio of 3:1 methyl silsesquioxane to methyl isobutyl ketone based on weight. The methyl silsesquioxane dissolved in the methyl isobutyl ketone is electrospun onto a silicon wafer, i.e., a collector, to form a plurality of fibers. The electrical potential between the nozzle and the collector is 30 kV. The gap between the nozzle and the collector is 25 cm. The flow rate of the methyl silsesquioxane dissolved in the methyl isobutyl ketone through the nozzle is 1 mL/min. The fibers are spun for about 1 minute. The fibers are pyrolyzed by heating the fibers from ambient temperature at a rate of 25° C./min until the fibers reach a temperature of 1,200° C. The fibers are heated at the temperature of 1,200° C. for one hour. The fibers are pyrolyzed in an environment comprising nitrogen gas and hydrogen gas, which are inert and free of oxygen, to form nanoparticles. The fibers are etched with an acidic solution comprising a 1:1:1 ratio of 49% hydrofluoric acid:alcohol:deionized water by submerging the fibers in the acidic solution to form the etched solution. The nanoparticles are removed from the etched solution by mixing the etched solution with an organic liquid comprising octane and methyl isobutyl ketone. The organic liquid, having the nanoparticles dispersed therein, is decanted from the etched solution. The nanoparticles are exposed to 365 nm ultraviolet light, during which the nanoparticles exhibit blue photoluminescence, as described in Table 1 below.

### Example 4

A silicon composition comprises hydrogen silsesquioxane and methyl silsesquioxane. The ratio of the hydrogen silsesquioxane to the methyl silsesquioxane is 3.75:1 based on weight. The hydrogen silsesquioxane and the methyl silsesquioxane are dissolved in methyl isobutyl ketone. The ratio of the combined weight of the hydrogen silsesquioxane and the methyl silsesquioxane to the weight of the methyl isobutyl ketone is 4:1. The hydrogen silsesquioxane and the methyl silsesquioxane dissolved in the methyl isobutyl ketone is electrospun onto a silicon wafer, i.e., a collector, to form a plurality of fibers. The electrical potential between the nozzle and the collector is 30 kV. The gap between the nozzle and the collector is 25 cm. The flow rate of the hydrogen silsesquioxane and the methyl silsesquioxane dissolved in the methyl isobutyl ketone through the nozzle is 1 mL/min. The fibers are spun for about 1 minute. The fibers are pyrolyzed by heating the fibers from ambient temperature at a rate of 25° C./min until the fibers reach a temperature of 1,200° C. The fibers are heated at the temperature of 1,200° C. for one hour. The fibers are pyrolyzed in an environment comprising nitrogen gas and hydrogen gas, which are inert and free of oxygen, to form nanoparticles. The fibers are etched with an acidic solution comprising a 1:1:1 ratio of 49% hydrofluoric acid:alcohol:deionized water by submerging the fibers in the acidic solution to form the etched solution. The nanoparticles are removed from the etched solution by mixing the etched solution with an organic liquid comprising octane and methyl isobutyl ketone. The organic liquid, having the nanoparticles dispersed therein, is decanted from the etched solution. The nanoparticles are exposed to 365 nm ultraviolet light, during which the nanoparticles exhibit green photoluminescence, as described in Table 1 below.

### Example 5

A silicon composition comprises hydrogen silsesquioxane and methyl silsesquioxane. The ratio of the hydrogen silsesquioxane to the methyl silsesquioxane is 3.75:1 based on weight. The hydrogen silsesquioxane and the methyl silsesquioxane are dissolved in methyl isobutyl ketone. The ratio of the combined weight of the hydrogen silsesquioxane and the methyl silsesquioxane to the weight of the methyl isobutyl ketone is 4:1. The hydrogen silsesquioxane and the methyl silsesquioxane dissolved in the methyl isobutyl ketone is electrospun onto a silicon wafer, i.e., a collector, to form a plurality of fibers. The electrical potential between the nozzle and the collector is 30 kV. The gap between the nozzle and the collector is 25 cm. The flow rate of the hydrogen silsesquioxane and the methyl silsesquioxane dissolved in the methyl isobutyl ketone through the nozzle is 1 mL/min. The fibers are spun for about 1 minute. The fibers are pyrolyzed by heating the fibers from ambient temperature at a rate of 25° C./min until the fibers reach a temperature of 1,500° C. The fibers are heated at the temperature of 1,500° C. for one hour. The fibers are pyrolyzed in an environment comprising nitrogen gas and hydrogen gas, which are inert and free of oxygen, to form nanoparticles. The fibers are etched with an acidic solution comprising a 1:1:1 ratio of 49% hydrofluoric acid:alcohol:deionized water by submerging the fibers in the acidic solution to form the etched solution. The nanoparticles are removed from the etched solution by mixing the etched solution with an organic liquid comprising octane and methyl isobutyl ketone. The organic liquid, having the nanoparticles dispersed therein, is decanted from the etched solution. The nanoparticles are exposed to 365 nm ultraviolet light, during which the nanoparticles do not exhibit photoluminescence, as described in Table 1 below.

TABLE 1

| | Pyrolyzing | Nanoparticle | Photoluminescent |
|---|---|---|---|
| Example | Temperature (° C.) | Size (nm) | Color |
| 1 | 1200 | 4 | Red |
| 2 | 1500 | 50-80 | None |
| 3 | 1200 | 2-3 | Blue |
| 4 | 1200 | 4 | Green |
| 5 | 1500 | 50-80 | None |

As shown in Table 1, the size of the nanoparticles produced by pyrolyzing the fibers is a function of the pyrolyzing temperature. For example, the silicon composition was the same in Example 1 and Example 2, and the difference in the temperature at which fibers formed from the silicon compositions were pyrolyzed, e.g. 1,200° C. versus 1,500° C., had a substantial impact on the size of the nanoparticles produced by pyrolyzing the fibers, e.g. 4 nm versus 50 to 80 nm. Similar results are seen in Example 4 and Example 5, both of which also utilize the same silicon composition. In addition, the silicon composition impacts the photoluminescent color of the nanoparticles produced by pyrolyzing the fibers formed from the silicon composition. For example, the silicon composition of Example 1 and Example 4 was different, but the parameters during the step of pyrolyzing the fibers formed from the silicon composition were the same, e.g. 1,200° C., and the photoluminescent color of the nanoparticles of Example 1 was red and the photoluminescent color of the nanoparticles of Example 4 was green.

The present invention has been described herein in an illustrative manner, and it is to be understood that the terminology which has been used is intended to be in the nature of words of description rather than of limitation. Obviously, many modifications and variations of the present invention are possible in light of the above teachings. The invention can be practiced otherwise than as specifically described within the scope of the appended claims.

1. A method of producing nanoparticles, said method comprising the steps of:
electrospinning a silicon composition to form fibers; and
pyrolyzing the fibers to produce the nanoparticles.

2. A method as set forth in claim 1 wherein the step of pyrolyzing the fibers comprises heating the fibers at a temperature of from 400 to 2,500° C.

3. A method as set forth in claim 2 wherein the step of heating the fibers comprises heating the fibers for a time of from 0.1 to 20 hours.

4. A method as set forth in claim 2 wherein the step of heating the fibers comprises increasing a temperature of the fibers of from ambient temperature to the temperature of from 400 to 2,500° C. at a rate of at least 5° C./minute.

5. A method as set forth in claim 2 wherein the step of heating the fibers at the temperature of from 400 to 2,500° C. comprises heating the fibers at a temperature of from 800 to 1,400° C. to produce the nanoparticles having an average diameter of from greater than zero to 7 nm.

6. A method as set forth in claim 2 wherein the step of heating the fibers at the temperature of from 400 to 2,500° C. comprises heating the fibers at a temperature of from greater than 1,400 to 2,500° C. to produce the nanoparticles having an average diameter of from greater than 7 to 500 nm.

7. A method as set forth in claim 1 wherein the step of pyrolyzing the fibers comprises plasma treating the fibers at a temperature of less than 400° C.

8. A method as set forth in claim 1 wherein the step of pyrolyzing the fibers comprises plasma treating the fibers for a time of from greater than zero to 10 minutes.

9. A method as set forth in claim 1 wherein the step of pyrolyzing the fibers is selected from the group of heating, plasma treating, and combinations thereof.

10. A method as set forth in claim 1 further comprising the step of isolating the nanoparticles from the fibers.

11. A method as set forth in claim 10 wherein the step of isolating the nanoparticles comprises etching the fibers with an acid solution to dissolve the fibers, thereby forming an etched solution.

12. A method as set forth in claim 11 wherein the step of isolating the nanoparticles further comprises the steps of mixing the etched solution with an organic liquid and separating the etched solution from the organic liquid, whereby the nanoparticles are dispersed in the organic liquid upon separation of the organic liquid from the etched solution.

13. A method as set forth in claim 1 wherein the silicon composition is selected from the group of hydrogen silsesquioxane, methyl silsesquioxane, disilane, polysilane, toluhydroquinone having at least one silicon atom, and combinations thereof.

14. A method as set forth in claim 1 wherein the silicon composition is in powder form and said method further comprises the step of dissolving the silicon composition in the powder form in a solvent.

15. A method as set forth in claim 1 wherein the nanoparticles comprise silicon nanoparticles.

16. A method as set forth in claim 15 wherein the nanoparticles further comprises nanoparticles selected from the group of silicon carbide nanoparticles, carbon nanoparticles, and combinations thereof.

17. A method as set forth in claim 1 wherein the nanoparticles have an average diameter of from greater than zero to 7 nm.

18. A method as set forth in claim 17 wherein the nanoparticles are photoluminescent.

19. A method as set forth in claim 1 further comprising the step of inducing photoluminescence of the nanoparticles by electromagnetic radiation.

20. Fibers comprising nanoparticles made in accordance with the method as set forth in claim 1.

21. Nanoparticles according to the method as set forth in claim 10.

22. A method as set forth in claim 7 wherein the step of pyrolyzing the fibers comprises plasma treating the fibers for a time of from greater than zero to 10 minutes.

23. A method as set forth in claim 7 wherein the nanoparticles have an average diameter of from greater than zero to 7 nm.
